(19) United States
(12) Patent Application Publication
(10) Pub. No.: US 2015/0261657 A1
(43) Pub. Date: Sep. 17, 2015

(54) METHODS FOR GENERATING TEST SUITES AND DEVICES THEREOF

(71) Applicant: Infosys Limited, Bangalore (IN)

(72) Inventors: Rupa Sravani Kommineni, Bangalore (IN); Anjaneyulu Pasala, Bangalore (IN); Vaibhav Ahlawat, Bangalore (IN); Luis Ignacio Moreno Aracena, Santiago (CL); Satya Prateek Bommaraju, Mumbai (IN)

(21) Appl. No.: 14/620,597

(22) Filed: Feb. 12, 2015

(30) Foreign Application Priority Data
Mar. 13, 2014 (IN) 1329/CHE/2014

(51) Int. Cl. G06F 11/36

(52) U.S. Cl. CPC G06F 11/3676; G06F 11/3684; G06F 11/3688; G06F 11/3692

(57) ABSTRACT

The technique relates to methods and devices for generating minimized test suites using a genetic algorithm. The technology involves generating a plurality of test cases corresponding to a plurality of test paths associated with an activity diagram of a software requirement specification thereafter obtaining a plurality of test coverage criteria for test suite minimization and finally determining a subset of the plurality of test cases which satisfies the plurality of test coverage criteria by using a multi objective optimization technique. The technology also involves prioritizing the subset of the plurality of test cases based on node defect probability wherein the node defect probability is determined by using a bug prediction technique based on previous bug history of the node thereafter the priorities are dynamically re-ordered during test execution.

This application claims the benefit of Indian Patent Application Serial No. 1329/CHE/2014 filed Mar. 13, 2014, which is hereby incorporated by reference in its entirety.

### FIELD

The present invention generally relates to generating minimized test suite, and in particular, to a system and method for generating minimized test suite using a genetic algorithm.

### BACKGROUND

Testing is one of a critical or important step in software development therefore continuous research being done to determine effective approaches in testing including test suite optimization and test suite prioritization approaches. The prevalent approaches involves delayed greedy algorithm suite, call tree construction, mutant analysis approach etc. The current approaches do not provide optimal results always with good test coverage and also, these approaches are tedious.

### SUMMARY

This technology overcomes the limitation mentioned above by providing a system and method for generating minimized test suite using a genetic algorithm.

According to an embodiment, a method for generating minimized test suite is disclosed. The method involves generating a plurality of test cases corresponding to a plurality of test paths associated with an activity diagram of a software requirement specification thereafter obtaining a plurality of test coverage criteria for test suite minimization and finally determining a subset of the plurality of test cases which satisfies the plurality of test coverage criteria by using a multi objective optimization technique. The method further comprises prioritizing the subset of the plurality of test cases based on node defect probability.

In an additional embodiment, a system a minimized test suit is disclosed. The system includes a test case generation component, a test coverage criteria obtaining component and an optimal test cases determination component. The test case generation component configured to generate a plurality of test cases corresponding to a plurality of test paths associated with an activity diagram of a software requirement specification. The test coverage criteria obtaining component configured to obtain a plurality of test coverage criteria for test suite minimization. The optimal test cases determination component configured to determine a subset of the plurality of test cases which satisfies the plurality of test coverage criteria by using a multi objective optimization technique. The system further comprises a test cases prioritization component configured to prioritize the subset of the plurality of test cases based on node defect probability.

In another embodiment, a non-transitory computer readable medium for generating a minimized test suit is disclosed. This involves a non-transitory computer readable medium having stored thereon instructions for generating a plurality of test cases corresponding to a plurality of test paths associated with an activity diagram of a software requirement specification thereafter obtaining a plurality of test coverage criteria for test suite minimization and finally determining a subset of the plurality of test cases which satisfies the plurality of test coverage criteria by using a multi objective optimization technique. The non-transitory computer readable media further comprises prioritizing the subset of the plurality of test cases based on node defect probability.

### BRIEF DESCRIPTION OF THE DRAWINGS

Various embodiments of this technology will, hereinafter, be described in conjunction with the appended drawings provided to illustrate, and not to limit the invention, wherein like designations denote like elements, and in which:

FIG. 1 is a computer architecture diagram illustrating a computing system capable of implementing the embodiments presented herein.

FIG. 2 is a flowchart, illustrating a method for generating minimized test suite, in accordance with an embodiment of the present technique.

FIG. 3 is an exemplary flowchart depicting a plurality of branches and nodes in an online shopping portal application.

FIG. 4 is a block diagram illustrating a system for generating minimized test suite, in accordance with an embodiment of the present technique.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

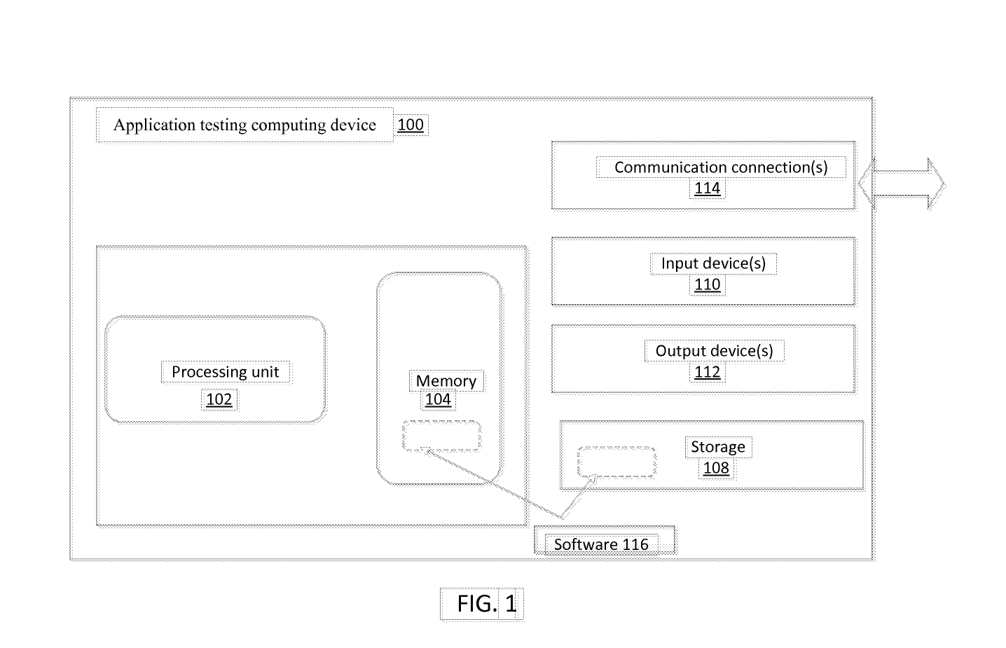

FIG. 1 illustrates an application testing computing device 100 in which all embodiments, techniques, and technologies may be implemented. The application testing computing device 100 is not intended to suggest any limitation as to scope of use or functionality of the technology. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 1, the application testing computing device 100 includes at least one central processing unit 102 and memory 104. The central processing unit 102 executes computer-executable instructions. In a multi-processing system, multiple processing units execute computer-executable instructions to increase processing power and as such, multiple processors can be running simultaneously. The memory 104 may be volatile memory (e.g., registers, cache, RAM), non-volatile memory (e.g., ROM, EEPROM, flash memory, etc.), or some combination of the two. The memory 104 stores software 116 that can implement the technologies described herein. A computing environment may have additional features. For example, the application testing computing device 100 includes storage 108, one or more input devices 110, one or more output devices 112, and one or more communication connections 114. An interconnection mechanism (not shown) such as a bus, a controller, or a network, interconnects the components of the application testing computing device 100. Typically, operating system software (not shown) provides an operating environment for other software executing in the application testing computing device 100, and coordinates activities of the components of the application testing computing device 100.

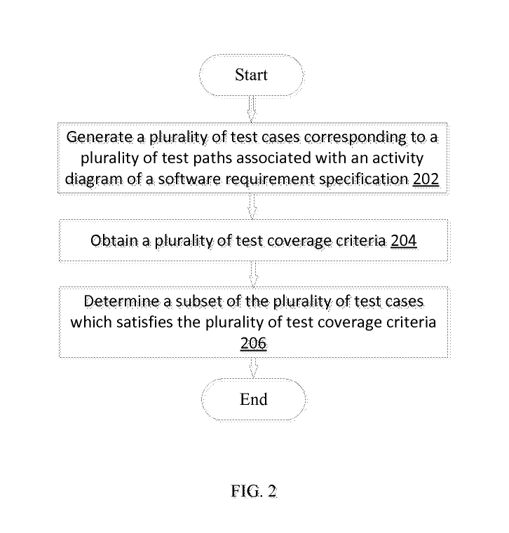

FIG. 2 is a flowchart, illustrating a method for generating a minimized test suite, in accordance with an embodiment of the present technique. A plurality of test cases corresponding to a plurality of test paths associated with an activity diagram of a software requirement specification is generated 202 thereafter a plurality of test coverage criteria for test suite minimization are obtained 204 and finally a subset of the plurality of test cases which satisfies the plurality of test coverage criteria by using a multi objective optimization technique are determined 206. The multi objective optimization technique includes use of Non-domination sorting algorithm. The test coverage criteria include, but are not limited to branch coverage, path coverage and conditional coverage.

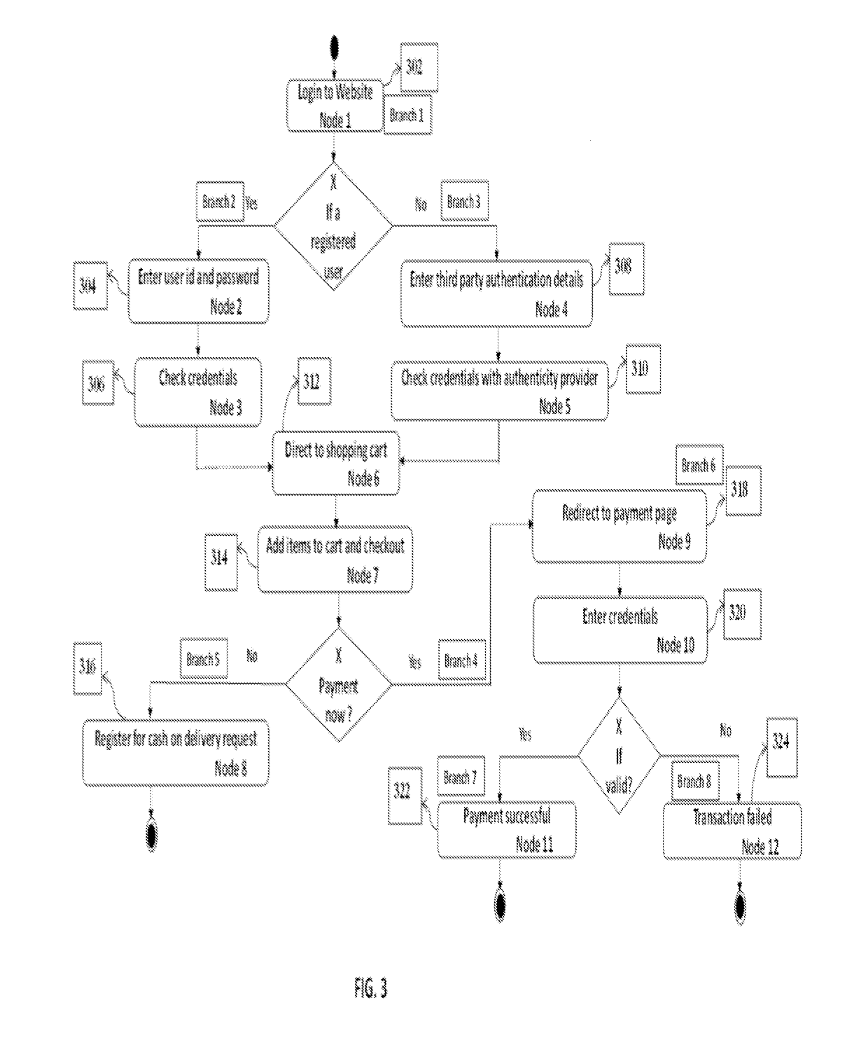

FIG. 3 is an exemplary flowchart depicting a plurality of branches and nodes in an online shopping portal application. The branch is an instruction in a computer program that may, when executed by a computer, cause the computer to begin execution of a different instruction sequence. According to an exemplary embodiment an online shopping portal involves a plurality of paths wherein a plurality of test cases are generated corresponding to a plurality of test paths associated with an activity diagram of a software requirement specification 203. The exemplary paths are shown below:

Path 1: Start→node1→decisionNode1→node4→node5→node6→node7→decisionNode2→node9→node10→decisionNode3→node11→End

Path 2: Start→node1→decisionNode1→node4→node5→node6→node7→decisionNode2→node9→node10→decisionNode3→node12→End

Path 3: Start→node1→decisionNode1→node4→node5→node6→node7→decisionNode2→node8→End

Path 4: Start→node1→decisionNode1→node4→node5→node6→node7→decisionNode2→node9→node10→decisionNode3→node11→End

Path 5: Start→node1→decisionNode1→node4→node5→node6→node7→decisionNode2→node9→node10→decisionNode3→node12→End

Path 6: Start→node1→decisionNode1→node4→node5→node6→node7→decisionNode2→node8→End

In order to optimize the test suite with no redundant paths taking branch coverage as test coverage criteria, consider the set of paths 1, 5 and 6 and the branches covered by them are shown in the table below.

TABLE 1

| | Branch | Branch | Branch | Branch | Branch | Branch | Branch | Branch |
|---|---|---|---|---|---|---|---|---|
| Paths | 1 | 2 | 3 | 4 | 5 | 6 | 7 | 8 |
| Path 1 | ✓ | | ✓ | ✓ | | ✓ | ✓ | |
| Path 5 | ✓ | ✓ | | ✓ | | ✓ | | ✓ |
| Path 6 | ✓ | ✓ | | ✓ | ✓ | | | |

Also, consider the set of paths 2, 3 and 4 and the branches covered by them are shown below:

TABLE 2

| | Branch | Branch | Branch | Branch | Branch | Branch | Branch | Branch |
|---|---|---|---|---|---|---|---|---|
| Paths | 1 | 2 | 3 | 4 | 5 | 6 | 7 | 8 |
| Path 2 | ✓ | | ✓ | ✓ | | ✓ | | ✓ |
| Path 3 | ✓ | | ✓ | ✓ | ✓ | | | |
| Path 4 | ✓ | ✓ | | ✓ | | ✓ | ✓ | |

From the above tables, it is clear that either the set of paths <1, 5 and 6> or the set of paths <2, 3 and 4> ensure 100% branch coverage individually however in the proposed technology all the paths from 1 to 6. This implies that the required testing criterion could be achieved by the subset of paths than full set of paths. For instance, if the test cases corresponding to paths 1, 5 and 6 satisfies the testing criteria. In that case, the test cases corresponding to paths 2, 3 and 4 are redundant. It shows that original test suite has about 50% redundancy in terms of number of test cases. Also, about 50% of the effort and resources may be saved during the testing phase, if that redundancy can be minimized.

According to an embodiment the multi objective optimization technique includes Non-domination Sorting Genetic Algorithm (NSGAII) which is based on a pareto ranking approach to address the issue of test suite minimization. Exemplary steps are explained below to minimize or optimize the test suite having test coverage criteria comprises maximum branch coverage with minimum number of the plurality of test cases.

Following are the terminologies used for the test suite minimization using NSGAII:
(i) Population: The set of all possible solutions at any instant (or in any generation). All the solutions are represented in a binary string format. Each possible solution in the population is called an individual.
(ii) Crossover & Mutation: Similar to evolution, solutions evolve to better ones by undergoing crossover and mutation. The population of a given generation undergoes crossover and mutation forms the population for next generation.
(iii) Front: A set of similar type of individuals. This term is frequently used in Pareto ranking approach.
(iv) Dominance: An individual A dominates another individual B if it is better than B with respect to at least satisfying one objective and worse with respect to none.

### Initial Population/Current Population

The NSGAII with an initial population. The initial population of a specified size consists of individuals that are generated randomly. In this heuristic, a test case as a bit (0 or 1) is represented and test suite as a binary string of length equal to maximum number of test cases. Here, the maximum number of test cases is the number of test cases in the to-be-minimized test suite. Each binary string forms an individual. These individuals are randomly generated to form initial population. Any individual in the population can be a possible solution as the minimized test suite.

For example, if the to-be-minimized test suite has 5 test cases and a sample test suite looks like ‘01001’, it implies a test suite that contains 2 test cases 2 & 5.

Once, the initial population is generated, the population is sorted in non-dominated fronts.

### Sort in Non-Dominated Fronts

Evolution is explained in evolutionary algorithms based on the “survival of the fittest” i.e., the individuals with weak fitness values are not carried forward to the next generation. The individuals are ranked based on their fitness using their characteristics with respect to the two objectives.

Any individual in the population has two metrics coverage and size, with respect to the two objectives Branch coverage and Test suite size respectively. The metric, coverage is equal to the number of branches covered by the test suite represented by the individual and the metric, size is equal to the number of test cases that the test suite represented by the individual consists of.

Based on these metrics, the population is sorted into non-dominated fronts as represented below:

While (all the individuals are not sorted)

Individuals that are better in at least one objective and worse
in none compared to other individuals in frontₖ₋₁ form the frontₖ.
k++

End

From the above, a front of individuals is formed in every iteration until all the individuals in the population are sorted. All the individuals in the first front are more dominant than the individuals in the rest of the fronts and individuals in second front more dominant than those of other fronts except first front and so on. In this way, all the individuals are ranked based on the front they belong to.

Considering a to-be-minimized test suite of size 4. The branch coverage of each test case in the suite is shown in the table 3 below.

TABLE 3

Branches

| Test Cases | B1 | B2 | B3 | B4 |
|---|---|---|---|---|
| T1 | ✓ | | ✓ | |
| T2 | ✓ | | | ✓ |
| T3 | | ✓ | ✓ | |
| T4 | | ✓ | | ✓ |

✓ in a cell represents that the test case covers the corresponding branch

In the table 3, T1, T2, T3 and T4 are the 4 test cases and B1, B2, B3 and B4 are the total branches in the UCAD model.

Assuming 1001 and 1100 are two individuals in the population i.e., 1001 is a test suite with test cases T1 & T4 and 1100 is a test suite with test cases T1 & T2. Hence, 1001 covers all the branches B1, B2, B3 & B4 and 1100 covers branches B1, B3 & B4 only. The metrics, coverage and size of the two individuals are shown in the table 4 below:

TABLE 4

| Metric | 1001 | 1100 |
|---|---|---|
| Coverage | 4 | 3 |
| Size | 2 | 2 |

From the above table, it is infer that 1001 ensures 100% branch coverage and 1100 ensures 75% branch coverage only. Also, both of them achieve the specified branch coverage with only two test cases.

As 1001 is better than 1100 with respect to coverage objective and not worse with respect to the size objective, 1001 dominates 1100. Hence, the formation of 1001's front takes place before the formation of 1100's front.

Once the individuals are sorted into fronts, the first front for the solution (i.e., test suite with less redundancy) is checked.

### Check for Program Termination/Best Possible Solution

The test suite with least redundancy is an NP-complete problem.

Hence, define an optimizing factor, “a” is defined to check for program termination. It denotes the percentage of redundancy in terms of number of test cases, need tend to reduce with respect to 100% branch coverage.

Let us say α=0.4. It implies that the heuristic tries to find a test suite whose size is optimized by 40% and ensuring 100% branch coverage simultaneously.

A solution may or may not exist for a given a. But the heuristic tries to find it for generations and will not terminate. Hence, another termination criterion is defined, maximum number of generations i.e., the program is terminated even though the solution is not found after the specified maximum number of generations.

The alternate termination criterion is user defined and in mentioned scenario it is terminated after maximum generations stating that the solution doesn't exist for the given a.

If none of the above termination criteria are met, NSGAII proceeds to the generation of new population similar to other evolutionary algorithms.

### Population Shrinking Using Crowding Distance Operator

The generation of new population may result in population explosion after a given time which are not controlled. Hence, to ensure the manageability of the population, it is shrunk to the given population size. Also, population shrinking removes the least eligible individuals so that their characteristics are not taken forward to the new generations. The crowding distance operator has been used perform population shrinking.

To remove the least eligible individuals from the population is equivalent to selecting the set of most eligible individuals of the given population size. As all the population is sorted into fronts and all the individuals in a given front are considered equivalent. Hence, a criterion is defined, crowding distance operator to select an individual over another from a given front.

NSGAII returns solutions that are widely spread in their domains i.e., the solutions belong to possibly different intervals. In other words, when an individual is selected it is also important that it should be less crowded with other possible individuals.

Crowding distance of an individual is defined with respect to an objective as the difference between the objective metric values of its neighbors. For instance, consider calculating crowding distance of an individual with respect to the objective, branch coverage. Hence, consider the corresponding metric, coverage.

Firstly, the individuals in the front are sorted in ascending order based on coverage and the crowding distance for any individual, k is calculated as follows:

crowding distancek=coveragek+1−coveragek−1

Using the above formula, the working of crowding operator is shown below:

For each individual in the front

crowding distance_{b}=crowding distance with respect to branch coverage

crowding distanceₛ=crowding distance with respect to size

crowding distance=crowding distance_{b}+crowding distanceₛ,

The crowding distance calculated is used for population shrinking as shown below:

For each front

If front size <= population size

population size = population size − front size

Add it to the population and go to next front
Else

Calculate crowding distance for each individual in

the front

Sort all individuals in descending order based on

crowding distance

Select first set of individuals of size population size

End

While (all the individuals are not sorted)

Individuals that are better in at least one objective and worse
in none compared to other individuals in frontₖ₋₁ form the frontₖ.
k++

End

The individuals with larger crowding distance are selected into the population i.e., the selected individuals are more widespread in the domain. The population formed after the shrinking takes part in the generation of new population using crossover & mutation operators.

### Crossover & Mutation of Population

Crossover and mutation are the two operators that are responsible for evolution by introducing new characteristics in the existing population. According to further exemplary embodiment single point crossover is considered. The selection technique used to select individuals for crossover is elitism. In elitism, the best individual is selected for crossover. The newly formed individuals are added to the existing population. Mutation introduces randomness in an individual. The mutation on the newly formed set of individuals resulting in the formation of next generation population is performed. If mutation is not performed on the old set of individuals, the convergence of any evolutionary algorithm highly depends on the initial population. Crossover and mutation operators in evolutionary algorithms ensure global optimal solution of any given problem. The NSGAII performs the above said operations in a single iteration. The algorithm continues for iterations and finds the solution with the given optimizing factor, if exist or the best solution till the termination criterion is met.

The above exemplary embodiment depicts the exemplary process of minimizing test suite.

This technology also involves prioritizing the subset of the plurality of test cases based on node defect probability wherein the node is a lowest scope of the prediction technique and can either be a statement, a method or a class. This depends on the type of data available as well as the type of testing that is done. The node defect probability is determined by using a bug prediction technique based on previous bug history of the node. The prioritizing the subset of the plurality of test cases is determined based on the probability of each test case to find at least one bug wherein the testing is a white box testing which tests internal structures or workings of an application. The priorities of the test cases are recalculated during execution time and arranged dynamically to ensure maximum code coverage as tested nodes have a lesser likelihood of being defective hence it ensures that test cases are not covering the same set of nodes over and over again.

It tests the paths within a unit, paths between units during integration, and between subsystems during a system-level test. This also influences the choice of “node” for the bug prediction.

According to an exemplary embodiment, with the path of nodes followed by each test case and the preventability of each node calculated using the bug prediction technique, if aim is to prioritize the test cases using their probability of finding at least one defect (Pₜ(β≧1)) then according to probability theory, “Probability of finding no bugs” (Pₜ(β=1)) plus “Probability of finding at least one bug” are independent events and their probability adds to one. Thus

Pₜ(β≧1)+Pₜ(β=0)+1

[symbol]

Pₜ(β≧1)=1−Pₜ(β=0)

The probability of not finding any bugs in a single test case is equal to the product of the probabilities of each node covered by that test case not being defective, which is one minus the preventability of that node.

$$∴ {P}_{t} ( β = 0 ) = {\prod }_{n ∈ {P}_{t}} ( 1 - {Preventability}_{n} )$$

Therefore the final probability of at least one bug detected by a test case is given by

$${P}_{t} ( β \geq 1 ) = 1 - {\prod }_{n ∈ {P}_{t}} ( 1 - {Preventability}_{n} )$$

After calculating these values the test cases are prioritized based on decreasing order of these values.

Thereafter, priorities are re-order during execution as there is a possibility that few of the test cases may be covering nodes that have already been tested by a previous test case. Thus to ensure optimal code coverage the priorities of test cases are dynamically.

The algorithm is described below:

Input:
Set T containing prioritized list of unexecuted test cases
Set N containing list of nodes that are already tested.
Set P containing the preventabilities of each node.

begin
Initialize N = Ø
while T ≠ Ø
for each ti ∈ T
if fraction of nodes in ti that ∈ N > Δ

Ignore ti

else if

Execute ti ,
Reduce preventability of each node covered by ti ,

Add the nodes tested to N if they don't already exist.

end for
Set N = Ø
Reprioritize tests in T based on Pₜ(β ≧ 1)
end

During execution test cases which have a fraction of already tested nodes greater than some fixed threshold are ignored. Every other test case is executed normally and then the nodes covered by those tests are penalized by some reduction factor. This reduction factor can be proportional to a constant “0>q>1” or an exponential decay.

For example if reduction is proportional to a constant then the preventability will be updated as

N_{g}*=q·N_{g}

Where; Ng is the node that has just been tested.

If an exponential update is used then each node is updated as

N_{g}⁺=e^{-q}·N_{g}

Where; q can either be a constant for each test case that passes through it or it could be the cost value for that test case. This cost depends on parameters of the test case such as execution time and the idea is to penalize test cases which have greater cost of execution.

Then the remaining unexecuted test cases are re-prioritized based on the newly calculated preventability values and the above step is repeated until all the tests have finished executing. The performance of test cases priority is evaluated by Average Percentage of Faults Detected Metric (APFD). As defined below:

“Let T be the test suite containing n test cases and let F be the set of m faults revealed by T. For ordering T′, let TFi be the order of the first test case that reveals the ith fault.”

The APFD value for T′ is calculated as following:

$$APFD = 1 - \frac{{\sum }_{i} T \cdot {F}_{i}}{n m} + \frac{1}{2 n}$$

APFD is computed after the test cases are executed and is evaluated to see the performance of the test suite.

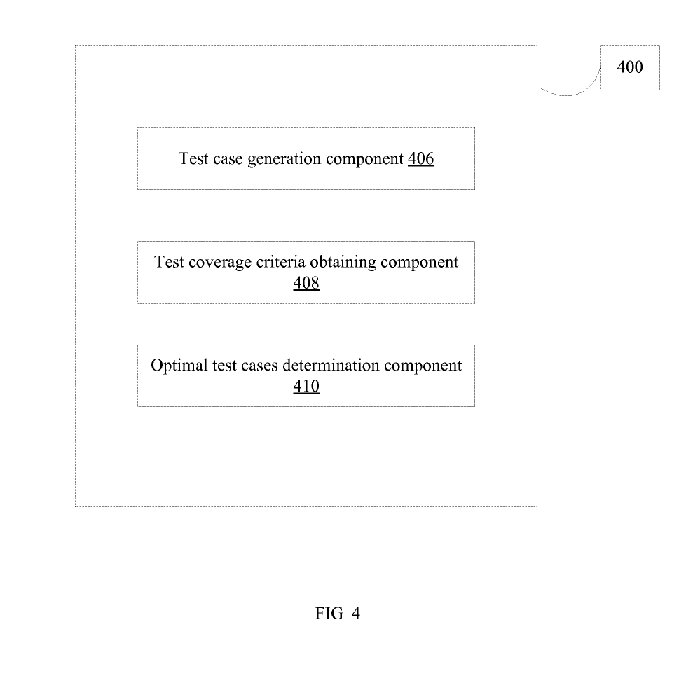

FIG. 4 is a block diagram illustrating a system for generating minimized test suite, in accordance with an embodiment of the present technique. More particularly system includes a test case generation component 406, a test coverage criteria obtaining component 408 and an optimal test cases determination component 410. The test case generation component configured to generate a plurality of test cases corresponding to a plurality of test paths associated with an activity diagram of a software requirement specification. The test coverage criteria obtaining component configured to obtain a plurality of test coverage criteria for test suite minimization. The optimal test cases determination component configured to determine a subset of the plurality of test cases which satisfies the plurality of test coverage criteria by using a multi objective optimization technique.

The above mentioned description is presented to enable a person of ordinary skill in the art to make and use this technology and is provided in the context of the requirement for obtaining a patent. Various modifications to the preferred embodiment will be readily apparent to those skilled in the art and the generic principles may be applied to other embodiments, and some features may be used without the corresponding use of other features. Accordingly, this technology is not intended to be limited to the embodiment shown but is to be accorded the widest scope consistent with the principles and features described herein.

What is claimed is:

1. A method for generating test suits, comprising:
generating, by an application testing computing device, a plurality of test cases corresponding to a plurality of test paths associated with an activity diagram of a software requirement specification;
obtaining, by the application testing computing device, test coverage criteria for test suite minimization;
determining, by the application testing computing device, a subset of the plurality of test cases that satisfy the test coverage criteria using a multi-objective optimization technique; and
outputting, by the application testing computing device, an indication of the determined subset of the plurality of test cases.

2. The method as set forth in claim 1, wherein the multi-objective optimization technique includes a Non-domination Sorting Genetic Algorithm.

3. The method as set forth in claim 1 further comprises prioritizing by the application testing computing device the subset of the plurality of test cases based on a defect probability for a node.

4. The method as set forth in claim 3, wherein the node defect probability is determined using a bug prediction technique based on a previous bug history of the node.

5. The method as set forth in claim 3, wherein the priorities are dynamically re-ordered during test execution.

6. An application testing computing device, comprising a processor and a memory coupled to the processor which is configured to be capable of executing programmed instructions comprising and stored in the memory to:
generate a plurality of test cases corresponding to a plurality of test paths associated with an activity diagram of a software requirement specification;
obtain test coverage criteria for test suite minimization;
determine a subset of the plurality of test cases that satisfy the test coverage criteria using a multi-objective optimization technique; and
output an indication of the determined subset of the plurality of test cases.

7. The application testing computing device as set forth in claim 6, wherein the multi objective optimization technique includes a Non-domination Sorting Genetic Algorithm.

8. The application testing computing device as set forth in claim 6 wherein the processor is further configured to be capable of executing at least one additional programmed instructions comprising and stored in the memory to prioritize the subset of the plurality of test cases based on a defect probability for a node.

9. The application testing computing device as set forth in claim 8, wherein the node defect probability is determined using a bug prediction technique based on a previous bug history of the node.

10. The application testing computing device as set forth in claim 8, wherein the priorities are dynamically re-ordered during test execution.

11. A non-transitory computer readable medium having stored thereon instructions for generating test suits comprising executable code which when executed by at least one processor, causes the processor to perform steps comprising:
generating a plurality of test cases corresponding to a plurality of test paths associated with an activity diagram of a software requirement specification;
obtaining test coverage criteria for test suite minimization;
determining a subset of the plurality of test cases that satisfy the test coverage criteria using a multi-objective optimization technique; and
outputting an indication of the determined subset of the plurality of test cases.

12. The non-transitory computer readable media as set forth in claim 11, wherein the multi objective optimization technique includes a Non-domination Sorting Genetic Algorithm.

13. The non-transitory computer readable media as set forth in claim 11 further having stored thereon instructions comprising executable code which when executed by the processor further causes the processor to perform steps further comprising prioritizing the subset of the plurality of test cases based on a defect probability for a node.

14. The non-transitory computer readable media as set forth in claim 13, wherein the node defect probability is determined using a bug prediction technique based on a previous bug history of the node.

15. The non-transitory computer readable media as set forth in claim 13, wherein the priorities are dynamically re-ordered during test execution.
